(19) United States
(12) Patent Application Publication
(10) Pub. No.: US 2026/0247056 A1
(43) Pub. Date: Aug. 20, 2026

(54) OUTSIDE MICROPHONE ARRANGEMENT FOR A VEHICLE

(71) Applicant: MERCEDES-BENZ GROUP AG, Stuttgart (DE)

(72) Inventor: Christian KOBETZ, Horb (DE)

(21) Appl. No.: 19/472,130

(22) PCT Filed: Feb. 23, 2024
(86) PCT No.: PCT/EP2024/054696

§ 371 Date: Oct. 3, 2025

(30) Foreign Application Priority Data
Apr. 6, 2023 (DE) 10 2023 001 367.6

(51) Int. Cl. H04R 1/08; B60S 1/56

(52) U.S. Cl. CPC H04R 1/083; B60S 1/56; H04R 2499/13

(57) ABSTRACT

An outside microphone arrangement for a vehicle includes a microphone arranged in a housing. The housing has at least one opening made therein for the entry of sound. The housing is coupled to a compressed air device.

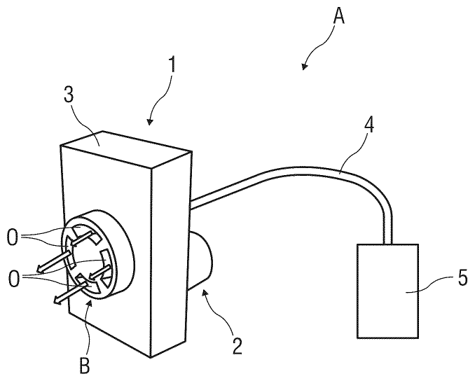

### BACKGROUND AND SUMMARY OF THE INVENTION

Exemplary embodiments of the invention relate to an outside microphone arrangement for a vehicle, having a microphone arranged in a housing, wherein the housing has at least one opening made therein for the entry of sound.

A cleaning unit for a vehicle imaging unit provided for recording the surroundings, a vehicle having such a cleaning unit and a method for operating such a cleaning unit is known from DE 10 2015 013 203 A1. The cleaning unit has a wiper fluid nozzle, which is provided to spray wiper fluid onto a transparent cover surface of the imaging unit. Additionally, a wiper is provided to mechanically dry the cover surface of the imaging unit. The cleaning unit also has a compressed air nozzle, which is provided to apply compressed air to the cover surface of the imaging unit.

Exemplary embodiments of the invention are directed to an outside microphone arrangement for a vehicle.

An outside microphone arrangement for a vehicle comprises a microphone arranged in a housing, wherein the housing has at least one opening made therein for the entry of sound. According to the invention, the housing is coupled to a compressed air device.

In this case, the compressed air device forms a cleaning unit for the microphone, wherein this can be cleared of dirt, snow and/or ice by means of the compressed air device, in particular the compressed air of same. By cleaning the microphone by means of compressed air, the risk of degradation of the microphone, the availability and functionality of which are absolutely essential in particular for carrying out automated driving operation of the vehicle, can be substantially reduced. Availability of the autonomous driving mode can also be increased by means of the compressed air device.

Using such a compressed air device as a cleaning unit can be more practical than using a cleaning unit based on water, in particular in relation to installation space requirements.

In one embodiment, the compressed air device has a compressed air hose fluidically coupled to an interior of the housing. In this case, the compressed air hose is designed, in particular, to be flexible and so installation of the compressed air hose into the installation space available in the vehicle is possible substantially without great effort.

In a further embodiment of the outside microphone arrangement, the interior of the housing is designed and coupled to the compressed air hose in such a way that compressed air introduced into the interior of the housing by means of the compressed air hose flows from the housing via the at least one opening. This means that if the at least one opening is covered or closed by snow, for example, the snow is removed by being blown away from the at least one opening by means of the out-flowing compressed air.

In one design, the compressed air hose is coupled to a compressed air reservoir at an end that is opposite to an end coupled to the interior of the housing. The compressed air reservoir releases compressed air as needed or prophylactically, which is supplied to the interior of the housing, in order to clear the opening of dirt, snow and/or ice. As the fluidic coupling of the interior of the housing to the compressed air reservoir takes place via the compressed air hose, it is not necessary for the compressed air reservoir to be arranged in the immediate vicinity of the microphone. The compressed air reservoir can be arranged in any available installation space, which can thus be used in an optimized manner. Alternatively or additionally, the opposite end can also be coupled to a ventilator.

In one embodiment, a region of the housing, in which the at least one opening is arranged, is arranged on the outside of the vehicle, in particular on a bumper unit, meaning that the at least one opening is exposed substantially unprotected to weather conditions and fouling.

In one embodiment, the region of the housing has four openings for the entry of sound, wherein these four openings can be used for the outflow of the air of the compressed air device that has been introduced into the interior of the housing.

In a further embodiment of the outside microphone arrangement, the compressed air device is designed to inject compressed air into the interior of the housing of the microphone, at least when the vehicle is started up. If snow and/or ice has been deposited on the at least one opening, it can be removed from the at least one opening by means of the compressed air device before starting a driving operation.

### BRIEF DESCRIPTION OF THE SOLE DRAWING FIGURE

Exemplary embodiments of the invention are explained in more detail in the following using the drawing, in which:

The sole drawing FIGURE schematically shows a perspective view of an outside microphone arrangement for a vehicle.

### DETAILED DESCRIPTION

The sole drawing FIGURE shows a perspective view of an outside microphone arrangement A for a vehicle (not shown).

The outside microphone arrangement A has a microphone 1 and a compressed air device 2.

Installed on a vehicle designed for automated driving, in particular autonomous driving, are several outside microphones, which, for example, detect special acoustic signals output by an emergency vehicle when the latter is in use, for example a vehicle belonging to the fire service, the police or a rescue service.

In order to be able to carry out distance and direction detection of the special signal relative to the vehicle, several such outside microphones are required on the vehicle. In particular, one outside microphone is arranged on the front and back, left and right in relation to the vehicle, respectively. Therefore, an installation position of the outside microphones is located on the front-side and rear-side bumper units of the vehicle. The bumper units are continuously exposed to comparatively heavy fouling and prevailing weather conditions, in particular in the driving operation of the vehicle.

The outside microphone arrangement A having the compressed air device 2, which forms a cleaning unit for the microphone 1, will be described hereinafter.

The microphone 1 has a housing 3 which, according to the present exemplary embodiment, comprises a circular-cylindrical region B that protrudes from a surface side and is arranged on the outside of the vehicle on the respective bumper unit.

This region B has four openings O, through which sound enters into the housing 3 and thus into the microphone 1. As these openings O are arranged on the outside with regard to the vehicle, there is the danger that the openings O will be clogged by dirt, snow and/or ice. Therefore, availability and functionality of the microphone 1 cannot be ensured, meaning that the microphone 1 is degraded and the autonomous driving operation of the vehicle has to aborted under certain circumstances or may not be able to start.

In order to clear fouling, snow and/or ice from the openings O of the microphone 1, the compressed air device 2 is provided.

The compressed air device 2 has a compressed air hose 4 and a compressed air reservoir 5, wherein compressed air can also be provided alternatively or additionally by means of a ventilator and/or another suitable device.

The compressed air hose 4 is comparatively flexible, so that it is possible to install the compressed air hose 4 comparatively simply and without great effort between the microphone 1 and the compressed air reservoir 5.

One end (not shown) of the compressed air hose 4 is coupled to an interior of the housing 3, wherein the compressed air reservoir 5 is arranged on the opposite end according to the present exemplary embodiment. Thus, the compressed air reservoir 5 is fluidically coupled to the interior of the housing 3 of the microphone 1.

Compressed air, which is released by means of the compressed air reservoir 5 and supplied to the interior of the housing 3 at a specified pressure via the compressed air hose 4, flows through the interior and outwards via the openings O, whereby the openings O are cleared of dirt, snow and/or ice. In other words: dirt, snow and/or ice is/are blown outwards from the openings O.

For example, the compressed air device 2 is activated when the vehicle is put into operation, i.e., an ignition is switched on. Alternatively or additionally, the compressed air device 2 is activated if it is intended to set the autonomous driving operation and/or if it is detected using a test run of the microphone 1 that an opening O or several openings O of the microphone 1 are covered.

Alternatively or additionally, the compressed air device 2 can also be activated when at least one further condition is satisfied, in which case it can also be possible that a driver, provided there is a driver in the vehicle, activates the compressed air device 2 by actuating an actuation element in the vehicle.

In one alternative embodiment of the compressed air device 2, at least one air nozzle is arranged outside on the region B or in its immediate vicinity, by means of which air nozzle the openings O are blown over with air and thus are cleared of dirt, snow and/or ice.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

1-7. (canceled)

8. An outside microphone arrangement for a vehicle, the outside microphone arrangement comprising:
a housing having at least one opening configured to allow sound to enter the housing;
a microphone arranged in the housing; and
a compressed air device coupled to the housing.

9. The outside microphone arrangement of claim 8, wherein the compressed air device has a compressed air hose fluidically coupled to an interior of the housing.

10. The outside microphone arrangement of claim 9, wherein the interior of the housing is configured and coupled to the compressed air hose in such a way that compressed air introduced into the interior of the housing by the compressed air hose flows out of the housing via the at least one opening.

11. The outside microphone arrangement of claim 9, wherein the compressed air hose is coupled to a compressed air reservoir at an end of the compressed air hose that is opposite to an end of the compressed air hose coupled to the interior of the housing.

12. The outside microphone arrangement of claim 8, wherein characterised in that a region of the housing in which the at least one opening is arranged is arranged on an outside of the vehicle.

13. The outside microphone arrangement of claim 12, wherein the at least one opening comprises four openings, which are arranged in the region of the housing.

14. The outside microphone arrangement of claim 9, wherein the compressed air device is configured to inject compressed air into the interior of the housing at least when the vehicle is started up.
